(19) United States
(12) Patent Application Publication
(10) Pub. No.: US 2005/0285989 A1
(43) Pub. Date: Dec. 29, 2005

(54) Liquid crystal display substrate and method of repairing the same

(75) Inventors: Hiroshi Sakurai, Kanagawa (JP); Shigeru Kimura, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC LCD TECHNOLOGIES, LTD.

(21) Appl. No.: 11/166,369

(22) Filed: Jun. 27, 2005

(30) Foreign Application Priority Data
Jun. 28, 2004 (JP) 190022/2004

(51) Int. Cl. G02F 1/136

(52) U.S. Cl. 349/44

(57) ABSTRACT

A liquid crystal display substrates includes a structure in which a light-shielding conductive film is formed on the same layer as gate bus lines in a space between a drain bus line and a transparent pixel electrode. A plurality of protrusions are formed on the drain bus line so as to protrude toward the light-shielding conductive film. Moreover, the light-shielding conductive film is formed to overlap the drain bus line only at the protrusions. When disconnection occurs on the drain bus line, the protrusions are welded and connected to the light-shielding conductive film by irradiating a laser beam onto the protrusions located on both sides of a disconnected portion so as to form an alternative path.

### BACKGROUND OF THE INVENTION

1. Field of the Invention

The present invention relates to a substrate for a liquid crystal display device and a method of repairing the same. More specifically, the present invention relates to a structure for allowing repair of disconnection of a line formed on a thin film transistor (TFT) substrate and a method of repairing the same.

2. Description of the Related Art

As a display device of an audio-visual (AV) machine and an office automation (OA) machine, a liquid crystal display device (LCD) has been widely used because of its merits including a thin thickness, a light weight, low power consumption and the like.

Moreover, among various LCDs, an active matrix LCD adopting thin film transistors (TFTs) as switching elements has been widely used.

This active matrix LCD interposes liquid crystal between a substrate including formation of switching elements such as TFTs (such a substrate will be hereinafter referred to as a TFT substrate) and a counter substrate including formation of color filters, a black matrix, and the like. A direction of alignment of liquid crystal molecules is changed by use of an electric field between electrodes respectively provided on the TFT substrate and on the counter substrate. Alternatively, the direction of alignment of the liquid crystal molecules is similarly changed by use of an electric field between a plurality of electrodes provided inside the TFT substrate. In this way, an amount of transmission of light is controlled in terms of each pixel. The former LCD is represented by a twisted nematic (TN) type LCD, and the latter LCD is represented by an in-plane switching (IPS) type LCD.

The TN type LCD includes a plurality of gate bus lines (also referred to as gate lines or scan lines), and drain bus lines (also referred to as drain lines, signal lines, or data lines) which are formed almost perpendicularly to the gate bus lines while interposing an interlayer insulation film such as a gate insulator film.

Moreover, the TFT substrate of the TN type LCD includes TFTs, which are provided in the vicinities of intersections of the gate bus lines and the drain bus lines. Each TFT is made of a semiconductor layer of an insular shape, and a gate of the TFT is connected to one of the gate bus lines and a drain thereof is connected to one of the drain bus lines. Furthermore, the TFT substrate of the TN type LCD includes transparent pixel electrodes made of indium tin oxide (ITO) or the like, each of which is formed in a region surrounded by the gate bus lines and the drain bus lines while interposing a passivation film and is connected to a source of the TFT. In addition, the TFT substrate of the TN type LCD includes light-shielding conductive films, each of which is formed in a region between the drain bus line and the transparent pixel electrode for shielding incident light in the periphery of the transparent pixel electrode.

In order to increase an aperture ratio of the LCD having the above-described structure, it is important to reduce widths of the gate bus lines and the drain bus lines. Here, the gate bus lines and the drain bus lines are normally formed by depositing a metal material such as chromium (Cr) by use of a sputtering method and the like. However, the Cr film formed by the sputtering method is not a fine film. Moreover, since the sputtering method cannot achieve sufficient coverage of uneven portions, these lines, more particularly the drain bus lines formed on an upper layer tend to be disconnected.

Meanwhile, disconnection may be caused by foreign substances and the like, which are mixed in the manufacturing process. If disconnection occurs in one position on these bus lines, pixels located behind the disconnected position cause defective display. As a result, disconnection will reduce yields of LCDs.

Therefore, to deal with disconnection occurring on the drain bus lines and the like, there has been disclosed a method of forming a disconnection repair line in advance for repairing disconnection so as to bypass a disconnected position through the repair line when disconnection happens.

For example, Japanese Unexamined Patent Publication No. 2000-310796 discloses a conventional TFT substrate 111. Specifically, as shown in FIG. 1, the conventional TFT substrate 111 applies a structure in which an auxiliary line 13 is formed in advance in a region for forming a drain bus line 6 upon formation of a gate bus line 2. Moreover, the publication discloses a structure configured to form a conductive coupling pattern 14 upon formation of a transparent pixel electrode 9, in which both ends of the conductive coupling pattern 14 are connected to an adjacent auxiliary line 13 at contacts 9a.

In addition, the publication discloses the structure configured to weld and connect overlapping portions of the drain bus line 6 and the auxiliary line 13 on both sides of a disconnected portion 12 by irradiating a laser upon occurrence of disconnection on the drain bus line 6 so as to bypass the disconnected portion 12 through a path formed of the auxiliary line 13 and the conductive coupling pattern 14.

Similarly, according to the above-mentioned publication, the auxiliary line 13 is formed upon formation of the gate bus line 2 in a region supposed to form the drain bus line 6. Furthermore, the publication also discloses a structure configured to form the conductive coupling pattern 14, in which both ends thereof are connected to the adjacent auxiliary line 13 at the contacts 9a and a central part thereof overlaps the drain bus line 6.

Moreover, the publication also discloses a structure configured to connect overlapping portions of the drain bus line 6 and the conductive coupling pattern 14 on both sides of the disconnected portion 12 by irradiating a laser upon occurrence of disconnection on the drain line 6, and thereby to bypass the disconnected portion 12 through a path formed of the auxiliary line 13 and the conductive coupling pattern 14.

In addition, according to the structure disclosed in the above-mentioned publication, upon occurrence of disconnection on the drain bus line 6, the overlapping portions of the drain bus line 6 and the repair line such as the auxiliary line 13 or the conductive coupling pattern 14 are connected. In other words, the drain bus line 6 and the repair line are connected to each other by irradiating a laser beam on the drain bus line 6.

However, as described previously, the widths of the gate bus lines 2 and the drain bus lines 6 in a recent LCD are reduced to increase an aperture ratio. When power of the laser is raised to connect the drain bus line 6 to the repair line with low resistance, the drain bus line 6 at the laser irradiated portion 10 disappears and the drain bus line 6 is thereby decoupled. As a result, a new disconnected portion is generated at the laser irradiated portion 10.

Moreover, the repair lines are formed separately from other lines such as the gate bus lines 2. However, the overlapping portion of the drain bus line 6 and the repair line is configured to cause parasitic capacitance because the metal films face each other while interposing an insulation film (which is a gate insulator in terms of the auxiliary line 13). This parasitic capacitance causes problems such as a delay in signal transmission on the drain bus line 6.

Therefore, it is necessary to reduce the overlapping portion of the drain bus line 6 and the repair line as small as possible. According to the method disclosed in the above-mentioned publication, the major part of the repair line, particularly of the auxiliary line 13, is formed below the drain bus line 6. In this case, it is impossible to reduce parasitic capacitance.

In this way, it is important to provide a LCD with a countermeasure for repair in the case of disconnection of the bus lines or more particularly the drain bus lines. In this regard, the LCD applies the structure configured to form the repair lines on the same layer as the gate bus lines. However, in order to connect the drain bus line to the repair line reliably upon repair and to reduce parasitic capacitance caused by providing the repair line, shapes and layouts of the drain bus lines and the repair lines are important technical factors.

The present invention has been made in consideration of the foregoing problems. An object of the present invention is to provide a LCD substrate and a method of repairing the LCD substrate, which are capable of forming a path so as to bypass a disconnected portion and thereby to avoid disconnection reliably. Another object of the present invention is to provide a LCD substrate and a method of repairing the LCD substrate, which are capable of reducing parasitic capacitance attributable to a repair line.

### SUMMARY OF THE INVENTION

To attain the objects, a liquid crystal display substrate of the present invention at least includes a plurality of first bus lines located on a lower layer and a plurality of second bus lines located on an upper layer and extending in a substantially orthogonal direction to the first bus lines, and switching elements disposed in the vicinities of intersections of the first bus lines and the second bus lines. In addition, the liquid crystal display substrate of the present invention at least includes transparent pixel electrodes formed inside respective pixel regions surrounded by the first bus lines and the second bus lines, and a light-shielding conductive film formed on the same layer as the first bus lines so as to surround part of a region between each of the second bus lines and each of the transparent pixel electrodes.

Moreover, in the liquid crystal display substrate of the present invention, the second bus line at least includes two protrusions in terms of each of the pixel regions. Here, each of the protrusions is configured to protrude toward the light-shielding conductive film and to include a portion overlapping the light-shielding conductive film from a viewpoint in a direction of a normal line of the substrate. Furthermore, the second bus line is connectable to the light-shielding conductive film by irradiating a laser beam onto the protrusions.

In the present invention, the protrusion may be formed so as to cross the light-shielding conductive film.

Meanwhile, in the present invention, the transparent pixel electrode may include a recessed portion in a position facing the protrusion so as to secure a clearance with the protrusion.

Meanwhile, in the liquid crystal display substrate of the present invention, the light-shielding conductive film at least includes two first protrusions in terms of each of the pixel regions. Here, each of the protrusions is configured to protrude toward the second bus line. Moreover, in the liquid crystal display substrate of the present invention, the second bus line includes second protrusions located in positions corresponding to the first protrusions. Here, each of the second protrusions is configured to protrude toward the light-shielding conductive film and to include a portion overlapping the first protrusion from a viewpoint in a direction of a normal line of the substrate. Furthermore, the second bus line is connectable to the light-shielding conductive film by irradiating a laser beam onto the second protrusions.

Meanwhile, a repairing method of the present invention is a method of repairing a liquid crystal display substrate at least including a plurality of first bus lines located on a lower layer and a plurality of second bus lines located on an upper layer and extending in a substantially orthogonal direction to the first bus lines, and switching elements disposed in the vicinities of intersections of the first bus lines and the second buslines. In addition, the repairing method of the present invention is the method of repairing the liquid crystal display substrate at least including transparent pixel electrodes formed inside respective pixel regions surrounded by the first bus lines and the second bus lines, and a light-shielding conductive film formed on the same layer as the first bus lines so as to surround part of a region between each of the second bus lines and each of the transparent pixel electrodes.

Moreover, the repairing method of the present invention is the method of repairing the liquid crystal display substrate in which the second bus line at least includes two protrusions in terms of each of the pixel regions. Here, each of the protrusions is configured to protrude toward the light-shielding conductive film and to include a portion overlapping the light-shielding conductive film from a viewpoint in a direction of a normal line of the substrate. Furthermore, in the repairing method of the present invention, the second bus line is connected to the light-shielding conductive film by irradiating a laser beam onto the protrusions provided on both sides of a disconnected portion when disconnection occurs on the second bus line. The repairing method of the present invention thus forms a path for bypassing the disconnected portion.

Meanwhile, the repairing method of the present invention is the method of repairing the liquid crystal display substrate in which the light-shielding conductive film at least includes two first protrusions in terms of each of the pixel regions. Here, each of the protrusions is configured to protrude toward the second bus line. Moreover, the repairing method of the present invention is the method of repairing the liquid crystal display substrate in which the second bus line includes second protrusions located in positions corresponding to the first protrusions. Here, each of the second protrusions is configured to protrude toward the light-shielding conductive film and to include a portion overlapping the first protrusion from a viewpoint in a direction of a normal line of the substrate. Furthermore, in the repairing method of the present invention, the second protrusions on the second bus line are connected to the first protrusions on the light-shielding conductive film by irradiating a laser beam onto the second protrusions provided on both sides of a disconnected portion when disconnection occurs on the second bus line. The repairing method of the present invention thus forms a path for bypassing the disconnected portion.

As described above, according to the configurations of the present invention, when disconnection occurs on the second bus line, the second bus line is connected to the light-shielding conductive film either at the protrusions or at the second protrusions provided on the second bus line by irradiating the laser beam either onto the protrusions or onto the second protrusions. In this way, it is possible to form the path for bypassing the disconnected portion. Moreover, in these configurations, it is possible to form the protrusions or the second protrusions into desired shapes even in the case of a product type configured to reduce widths of the bus lines in order to increase an aperture ratio. Accordingly, even when power of the laser is raised to reduce resistance of joint portion, the metal at the laser irradiated portion will not disappear, so that no new disconnected portion will be caused at the laser irradiated portion. In addition, since the overlapping portion of the second bus line and the light-shielding conductive film is restricted to the protrusion or the second protrusion, it is possible to reduce parasitic capacitance.

### BRIEF DESCRIPTION OF THE DRAWINGS

FIG. 1 is a plan view showing a structure of a TFT substrate in a conventional LCD, which is disclosed in Japanese Unexamined Patent Publication No. 2000-310796.

FIG. 2 is a plan view showing a structure of a TFT substrate in another conventional LCD, which is disclosed in Japanese Patent No. 3097829.

FIG. 3 is a plan view schematically showing a structure of one pixel on a TFT substrate according to an embodiment of the present invention.

FIG. 4A is a plan view showing a manufacturing process of the TFT substrate according to the embodiment of the present invention.

FIG. 4B is a cross-sectional view taken along the I-I line in FIG. 4A.

FIG. 5A is another plan view showing the manufacturing process of the TFT substrate according to the embodiment of the present invention.

FIG. 5B is a cross-sectional view taken along the II-II line in FIG. 5A.

FIG. 6A is another plan view showing the manufacturing process of the TFT substrate according to the embodiment of the present invention.

FIG. 6B is a cross-sectional view taken along the III-III line in FIG. 6A.

FIG. 7A is a plan view showing a repairing process for a drain bus line according to the embodiment of the present invention.

FIG. 7B is a cross-sectional view taken along the IV-IV line in FIG. 7A.

FIG. 8 is a plan view showing a variation of shapes of the drain bus line, a light-shielding conductive film, and a transparent pixel electrode on the TFT substrate according to the embodiment of the present invention.

FIG. 9 is a plan view showing another variation of the shapes of the drain bus line, the light-shielding conductive film, and the transparent pixel electrode on the TFT substrate according to the embodiment of the present invention.

FIG. 10 is a plan view showing another variation of the shapes of the drain bus line, the light-shielding conductive film, and the transparent pixel electrode on the TFT substrate according to the embodiment of the present invention.

FIG. 11 is a plan view showing another variation of the shapes of the drain bus line, the light-shielding conductive film, and the transparent pixel electrode on the TFT substrate according to the embodiment of the present invention.

FIG. 12 is a plan view showing another variation of the shapes of the drain bus line, the light-shielding conductive film, and the transparent pixel electrode on the TFT substrate according to the embodiment of the present invention.

FIG. 13 is a plan view showing another variation of the shapes of the drain bus line, the light-shielding conductive film, and the transparent pixel electrode on the TFT substrate according to the embodiment of the present invention.

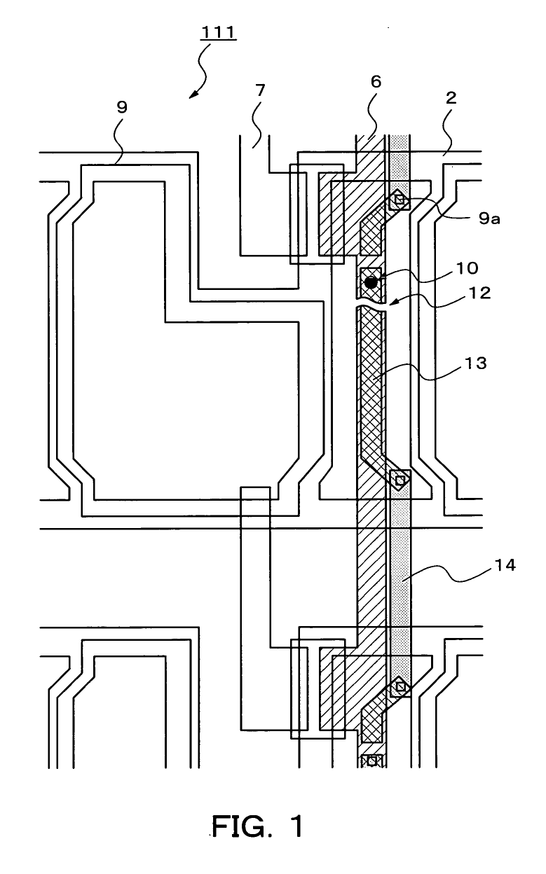

### DETAILED DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposes.

In a conventional LCD, disconnection is apt to occur on a bus line, particularly on a drain bus line which is formed on an upper layer. In the LCD, when disconnection occurs on a drain bus line in terms of one pixel out of pixels arranged in a matrix, subsequent pixels cause defective display and an yield of the LCD is thereby degraded. Accordingly, a light-shielding conductive film for shielding light around a transparent pixel electrode, which is formed on the same layer as a gate bus line, is used as a repair line for repairing disconnection on the drain bus line. Moreover, when disconnection occurs on the drain bus line, it is possible to form an alternative path by welding and connecting the drain bus line to the light-shielding conductive film on both sides of a disconnected portion using laser irradiation. However, the structure configured to connect the repair line (an auxiliary line 13) to the drain bus line on the drain bus line causes the following problem. As disclosed in the publication quoted above, in terms of the product type configured to reduce the widths of the drain bus lines in order to increase the aperture ratio, the drain bus line at a laser irradiated portion disappears and the drain bus line is thereby decoupled when power of a laser is raised for reducing resistance of joint portion. As a result, new disconnected portion may be caused at the laser irradiated portion.

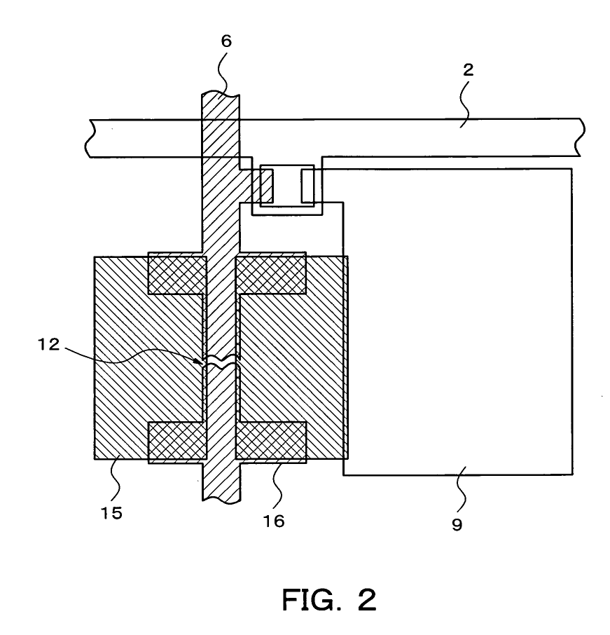

In terms of this problem, the inventor of the present invention has proposed a configuration shown in FIG. 2 in Japanese Patent No. 3097829. This conventional TFT substrate 211 applies a structure in which a drain bus line 6 is provided with protrusions 16 and a light-shielding conductive film 15 constituting a repair line is connected to the protrusions 16 by irradiating a laser beam onto the protrusions 16. By using this structure, even if the power of the laser is raised in terms of a product type configured to reduce the widths of the drain bus lines 6 of the conventional TFT substrate 211, the drain bus line 6 is prevented from decoupling.

Here, upon formation of a new line (the repair line) inside a pixel, it is necessary to consider an interaction between the new line and other existing lines (particularly the drain bus lines 6). Since parasitic capacitance is generated at an overlapping portion of the repair line and the drain bus line 6, it is also important to consider a countermeasure for reducing parasitic capacitance. However, according to the structure of the conventional TFT substrate 111 configured to form the major part of the repair line (the auxiliary line 13) below the drain bus line 6, the area of the overlapping portion of the drain bus line 6 and the repair line is increased. Accordingly, parasitic capacitance is increased and a signal delay on the drain bus line becomes noticeable. Meanwhile, in the case of providing the drain bus line 6 with the protrusions 16, when shapes and the layouts of the drain bus line 6 and the repair line (the light-shielding conductive film 15) are designed as shown in FIG. 2, the repair line overlaps not only the protrusions 16 of the drain bus line 6 but also a base portion (a body of the drain bus line 6). For this reason, it is not possible to reduce parasitic capacitance between the drain bus line 6 and the repair line effectively.

Therefore, a TFT substrate 11 of the present invention applies a structure in which a light-shielding conductive film constituting a repair line is formed on the same layer as a gate bus line in a space between a drain bus line and a transparent pixel electrode. Here, at least two protrusions are provided in terms of each pixel so as to protrude toward the light-shielding conductive film and to overlap the light-shielding conductive film from a viewpoint in a direction of a normal line of the substrate. Moreover, the drain bus line is formed to be connectable to the light-shielding conductive film at the protrusions. Accordingly, when disconnection occurs on the drain bus line, the protrusions are welded and connected to the light-shielding conductive film by irradiating a laser beam onto the protrusions located on both sides of a disconnected portion, thereby forming an alternative path.

In the TFT substrate 11 of the present invention of a low-resistance product type having reduced widths of bus lines, a base portion of the drain bus line 6 will not disappear even in the case of raising the power of the laser. In addition, this TFT substrate 11 can reduce parasitic capacitance between the drain bus line 6 and the repair line. In this structure, even in the case of the product type having the reduced widths of the drain bus lines, the shapes of the protrusions are not restricted. Accordingly, it is possible to design the drain bus lines into desired widths. Therefore, even if the power of the laser is raised for lower resistance, the metal at the laser irradiated portion will not disappear, so that no new disconnected portion will be caused at the laser irradiated portion. In addition, since the drain bus line overlaps the light-shielding conductive film only by use of the protrusions, it is possible to reduce parasitic capacitance sufficiently. In the following, concrete configurations of the embodiment will be described with reference to the accompanying drawings. (An exemplary embodiment of the present invention)

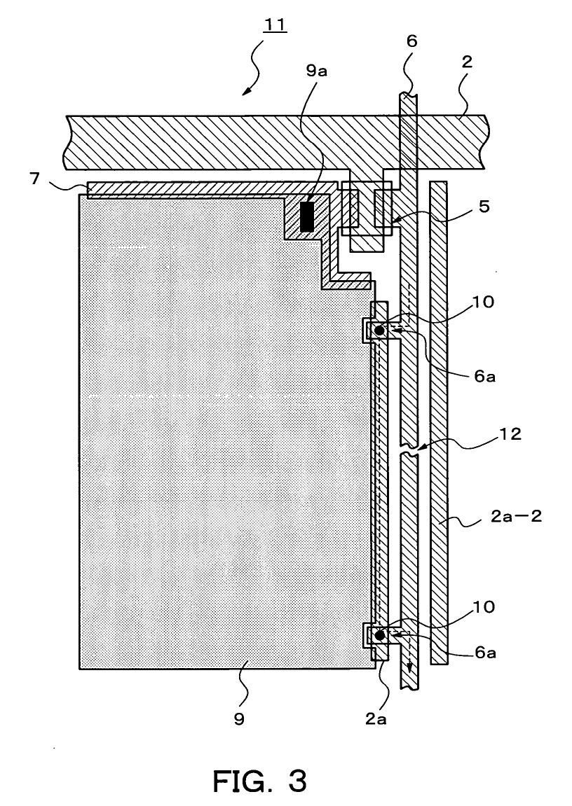

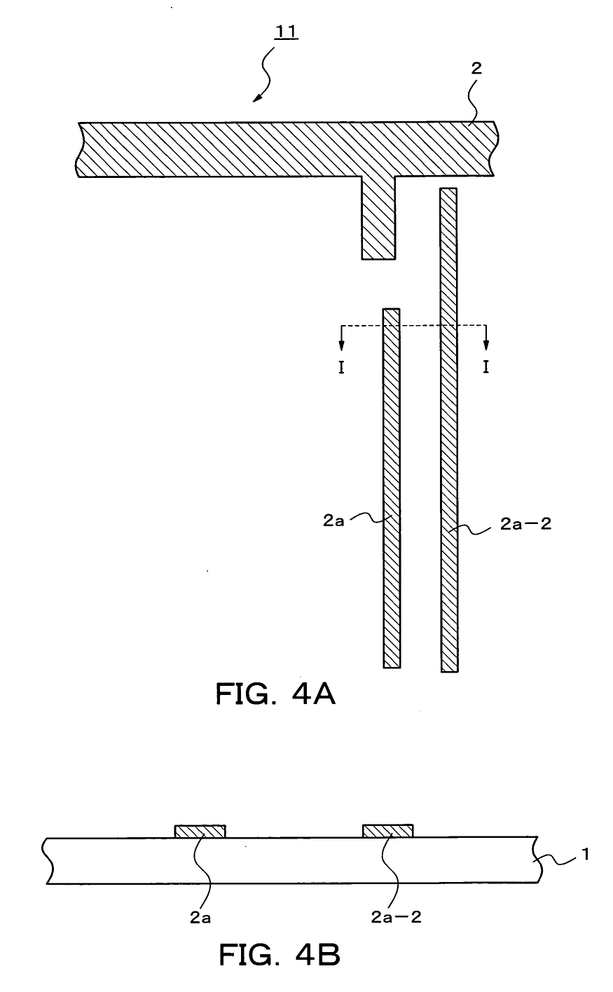

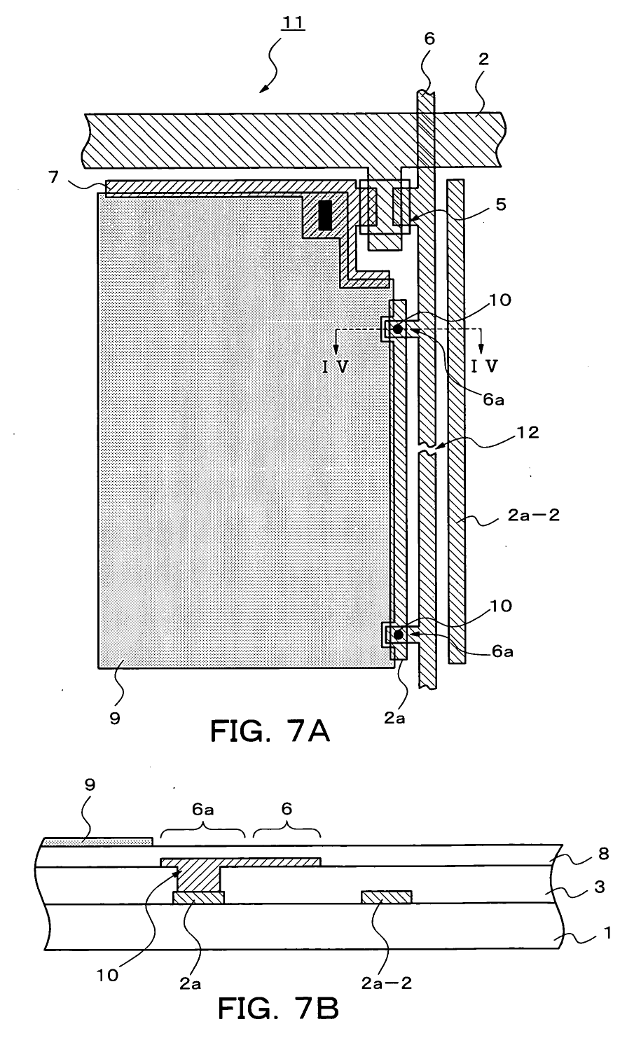

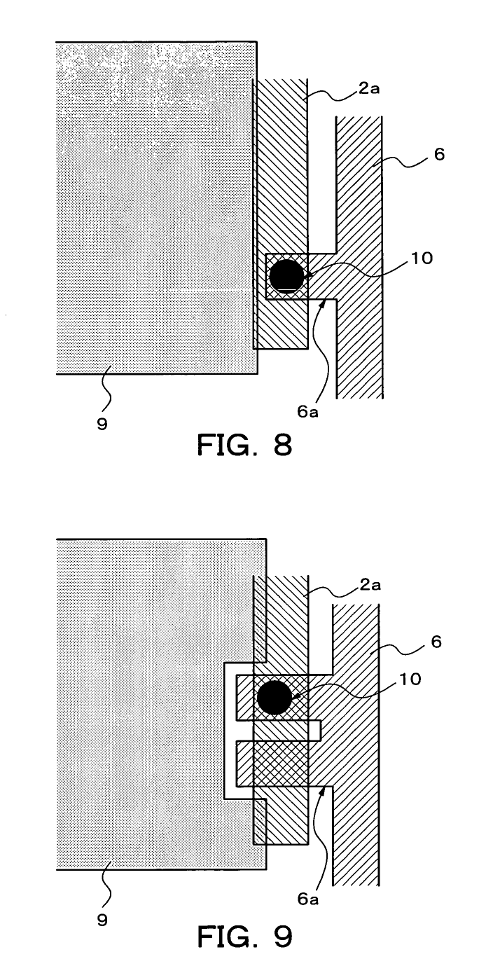

An LCD substrate and a method of repairing disconnection of a drain bus line according to an exemplary embodiment of the present invention will be described with reference to FIG. 3 to FIG. 13. FIG. 3 is a plan view schematically showing a structure of one pixel on a TFT substrate according to the exemplary embodiment of the present invention. FIG. 4A to FIG. 6B are plan views and cross-sectional views showing a manufacturing process of the TFT substrate according to the exemplary embodiment of the present invention. FIG. 7A is a plan view showing are pairing process for a drain bus line. FIG. 7B is a cross-sectional view showing the repairing process for the drain bus line. Moreover, FIG. 8 to FIG. 13 are plan views showing variations of shapes of the drain bus line, a light-shielding conductive film, and a transparent pixel electrode according to the exemplary embodiment of the present invention.

Firstly, a structure of the LCD substrate of the exemplary embodiment of the present invention will be described based on a reverse stagger TFT substrate used for a TN type LCD as an example.

As shown in FIG. 3, a TFT substrate 11 includes a plurality of gate bus lines 2 extending in one direction, and a plurality of drain bus lines 6 extending in a substantially orthogonal direction to the gate bus lines 2 while interposing a gate insulator film. Moreover, the TFT substrate 11 includes a TFT 5, which is located in the vicinity of each intersection of the gate bus lines 2 and the drain bus lines 6 and is formed by use of a semiconductor layer such as amorphous silicon or polysilicon. Here, a gate electrode of the TFT 5 is connected to the gate bus line 2 and a drain electrode thereof is connected to the drain bus line 6. Moreover, inside each pixel region surrounded by the gate bus lines 2 and the drain bus lines 6, the TFT substrate 11 includes a transparent pixel electrode 9, which is connected to a source electrode 7 of the TFT 5 at a contact 9a. Meanwhile, in the TFT substrate 11, a light-shielding conductive film 2a and a light-shielding conductive film 2a-2 for shielding incident light in the periphery of the transparent pixel electrode 9 is formed on the same layer as the gate bus lines 2 so as to surround part of a region between the drain bus line 6 and the transparent pixel electrode 9.

On the drain bus line 6, at least two protrusions 6a protruding in a direction toward the light-shielding conductive film 2a is formed in two positions in terms of each pixel. Each of the protrusions 6a extends to an edge of the light-shielding conductive film 2a close to the transparent pixel electrode 9 so as to cross the light-shielding conductive film 2a. Meanwhile, long edges of the light-shielding conductive film 2a are formed so as to extend substantially in parallel to the drain bus line 6. Moreover, to reduce parasitic capacitance caused together with the drain bus line 6, the light-shielding conductive film 2a is formed so as to overlap the drain bus line 6 only at the protrusions 6a. In addition, to shield the light around the transparent pixel electrode 9, the light-shielding conductive film 2a is formed so as to overlap a peripheral portion of the transparent pixel electrode 9. Meanwhile, since undesirable parasitic capacitance is generated when the drain bus line 6 overlaps the transparent pixel electrode 9, the transparent pixel electrode 9 is provided with recessed portions which are formed into shapes corresponding to the protrusions 6a so as to secure distances from the protrusions 6a.

Moreover, although the following constituents are not illustrated herein, a counter substrate facing the TFT substrate 11 includes color filters for performing color display in respective colors of RGB, a black matrix for shielding incident light in the peripheries of transparent pixel electrodes 9 on the TFT substrate 11, and a counter electrode made of ITO, all of which are formed on a transparent insulative substrate. In addition, alignment films are formed on mutually opposed surfaces of the both substrates. A desired gap is formed by attaching the both substrates together while interposing spacers. A LCD is formed by interposing liquid crystal in this gap.

Then, a display function is tested by displaying an appropriate display pattern on the LCD. When disconnection is found in the drain bus line 6, the protrusions 6a located on both sides of a disconnected portion 12 are welded and connected to the light-shielding conductive film 2a by irradiating a laser beam onto the protrusions 2a with a laser irradiation apparatus. In this way, an alternative path is formed as indicated by a dashed line in the drawing, thereby dissolving a line defect while avoiding disconnection on the drain bus line 6.

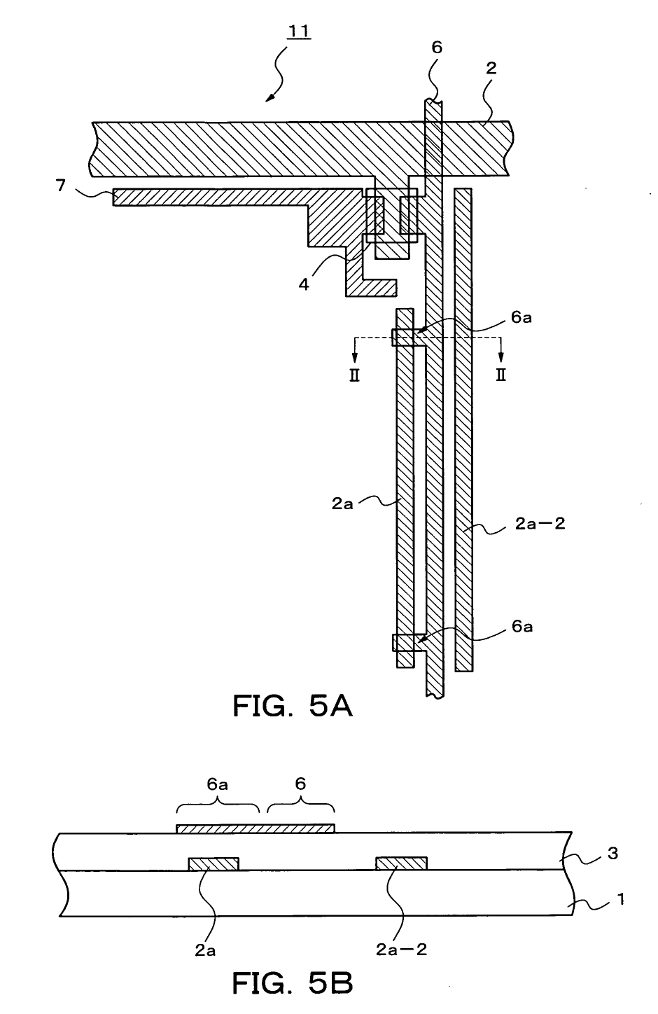

Next, a method of manufacturing the TFT substrate 11 having the above-described structure and a method of repairing the drain bus line 6 will be explained with reference to FIG. 4A to FIG. 5B.

Firstly, as shown in FIG. 4A and FIG. 4B, any of Cr, Mo, Al, alloys thereof, or the like is deposited in a thickness of several hundreds of nanometers on a transparent insulative substrate 1 such as a glass substrate by use of a sputtering method, for example. Thereafter, a first resist pattern is formed by use of a publicly known lithographic technique. Then, the metal is subjected to wet etching by use of an etchant such as mixed acid of phosphoric acid, nitric acid and acetic acid while using the first resist pattern as a mask. In this way, the gate bus line 2 and the gate electrode to be connected to the gate bus line 2 are formed. Simultaneously, the light-shielding conductive film 2a and the light-shielding conductive film 2a-2 for shielding the light around the transparent pixel electrode 9 and constituting a repair line for repairing disconnection on the drain bus line 6 is formed in a predetermined region between the drain bus line 6 to be formed in a subsequent process and the transparent pixel electrode 9.

The light-shielding conductive film 2a is formed away from the gate bus line 2. Moreover, from a viewpoint in a direction of a normal line of the substrate, a portion where the light-shielding conductive film 2a overlaps the drain bus line 6 is formed into a structure in which the metal films face each other while interposing a gate insulator film to be formed in a subsequent process. Accordingly, parasitic capacitance is generated. As a result, signal transmission on the drain bus line is delayed.

Therefore, in the exemplary embodiment of the present invention, in order to avoid occurrence of unnecessary parasitic capacitance involving the drain bus line 6, the light-shielding conductive film 2a is formed not to overlap a base portion of the drain bus line 6 but to overlap only the protrusions 6a which are branched off from the drain bus line 6. Meanwhile, in the TN type LCD, liquid crystal molecules are turned by use of an electric field between the transparent pixel electrode 9 on the TFT substrate 11 and the counter electrode on the counter substrate. However, at peripheral portions of the transparent pixel electrode, the electric field becomes uneven and display quality is thereby degraded. Accordingly, it is necessary not to allow incident light such as backlight around the transparent pixel electrode 9. The light-shielding conductive film 2a is formed so as to overlap the peripheral portion of the transparent pixel electrode 9. Here, the width and the length of the light-shielding conductive film 2a are not particularly limited. However, resistance of the alternative path is increased when the width of the light-shielding conductive film 2a is reduced. Accordingly, the width of the light-shielding conductive film 2a may be appropriately set up so as to achieve specific resistance substantially equal to that of the drain bus line 6. Moreover, if the width becomes smaller than a diameter of the laser beam to be used for repair, the metal may disappear when the power of the laser is raised. Accordingly, the width is set substantially equal to or above the diameter of the laser beam. In other words, it is also possible to set the width of the light-shielding conductive film 2a equal to the width of the protrusion 6a to be formed later, so that the overlapping portion is formed into a substantially square shape. In this case, it is easier to irradiate the laser beam thereon.

Next, as shown in FIG. 5A and FIG. 5B, a gate insulator film. 3 made of a silicon oxide film, a silicon nitride film or lamination of these films is deposited in a thickness of several hundreds of nanometers by use of plasma CVD method, for example. Subsequently, amorphous silicon, polysilicon or the like constituting a semiconductor layer 4 of the TFT 5 is deposited in a thickness of several hundreds of nanometers. Thereafter, dry etching is performed while using a second resist pattern formed on the resultant surface as a mask. In this way, amorphous silicon or polysilicon is patterned to form the semiconductor layer 4 of an insular shape. Next, metal such as chromium (Cr), Molybdenum (Mo) or Aluminum (Al), or an alloy thereof is deposited in a thickness of several hundreds of nanometers by use of sputtering method, for example. Thereafter, the metal is subjected to wet etching by use of an etchant such as ceric ammonium nitrate while using a third resist pattern formed thereon as a mask. In this way, the drain bus line 6, and the drain electrode as well as the source electrode 7 to be connected to the drain bus line 6 are formed.

Here, in the case of forming the TFT substrate 11 without a repairing structure, the drain bus line 6 may be formed as a straight line. However, in the exemplary embodiment of the present invention, at least two protrusions 6a are provided in terms of each pixel (in mutually distant positions on an upper side and a lower side of each pixel, for example) in order to provide the alternative path against disconnection on the drain bus line 6. These protrusions 6a are formed so as to protrude toward the light-shielding conductive film 2a and to overlap the light-shielding conductive film 2a. Although the shape of the protrusion 6a is not particularly limited, an increase in the width of the protrusion 6a may cause an increase in the area of the portion overlapping the light-shielding conductive film 2a and incur an increase in parasitic capacitance. On the contrary, a decrease in the width of the protrusion 6a may cause the protrusion 6a to disappear when the power of the laser is raised. In this context, it is preferable to set the width of the protrusion 6a substantially equal to or above the width of the diameter of the laser beam.

Moreover, as shown in the drawings, in order to allow tolerance in manufacturing, a tip end of the protrusion 6a is formed so as to cross the light-shielding conductive film 2a completely and to protrude out of the light-shielding conductive film 2a. Furthermore, the tip end of the protrusion 6a may be substantially aligned with the edge of the light-shielding conductive film 2a located close to the transparent pixel electrode 9. In addition, as shown in FIG. 8, it is also possible to form the tip end of the protrusion 6a to stay in the light-shielding conductive film 2a. In the configuration shown in FIG. 8, it is possible to prevent the transparent pixel electrode 9 from overlapping the protrusion 6a even when the light-shielding conductive film 2a overlaps the peripheral portion of the transparent pixel electrode 9. In this case, it is not necessary to provide the transparent pixel electrode 9 with the recessed portions so as to correspond to the protrusions 6a.

Meanwhile, in order to form the alternative path, at least two protrusions 6a are necessary in each pixel. In the drawings, one protrusion 6a is formed on an upper part of the pixel while another protrusion 6a is formed on a lower part thereof. However, the number of the protrusions 6a is not limited only to two. For example, as shown in FIG. 9, it is also possible to provide two protrusions 6a in each location in order to reduce resistance of the joint or to prepare an extra protrusion in case of a joint failure. Moreover, it is also possible to provide three or more protrusions 6a on the upper part, the lower part, and in the middle in order to reduce the length of the alternative path as short as possible.

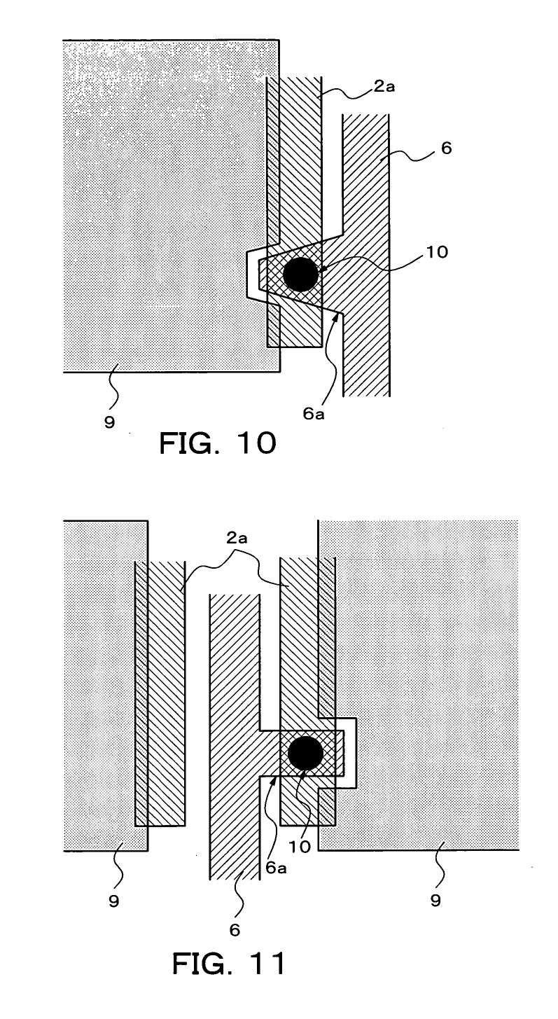

In the drawings, the long edges of the protrusion 6a are formed so as to cross almost perpendicularly to long edges of the drain bus line 6 or long edges of the light-shielding conductive film 2a. The shape, the direction of the long edges, and the like of the protrusion 6a may be designed arbitrarily. For example, it is also possible to form the protrusion 6a so as to protrude obliquely relative to the long edges of the drain bus line 6 or the long edges of the light-shielding conductive film 2a. Alternatively, it is also possible to form the protrusion into a gradually tapered trapezoidal shape in order to reduce resistance at the protrusion 6a and to reduce the area of the portion overlapping the light-shielding conductive film 2a (see FIG. 10).

Here, as described previously, an increase in the area of the overlapping portion of the protrusion 6a and the light-shielding conductive film 2a causes an increase in parasitic capacitance. Accordingly, it is essential to consider an effect of parasitic capacitance upon setting of the number and the shape of the protrusions 6a.

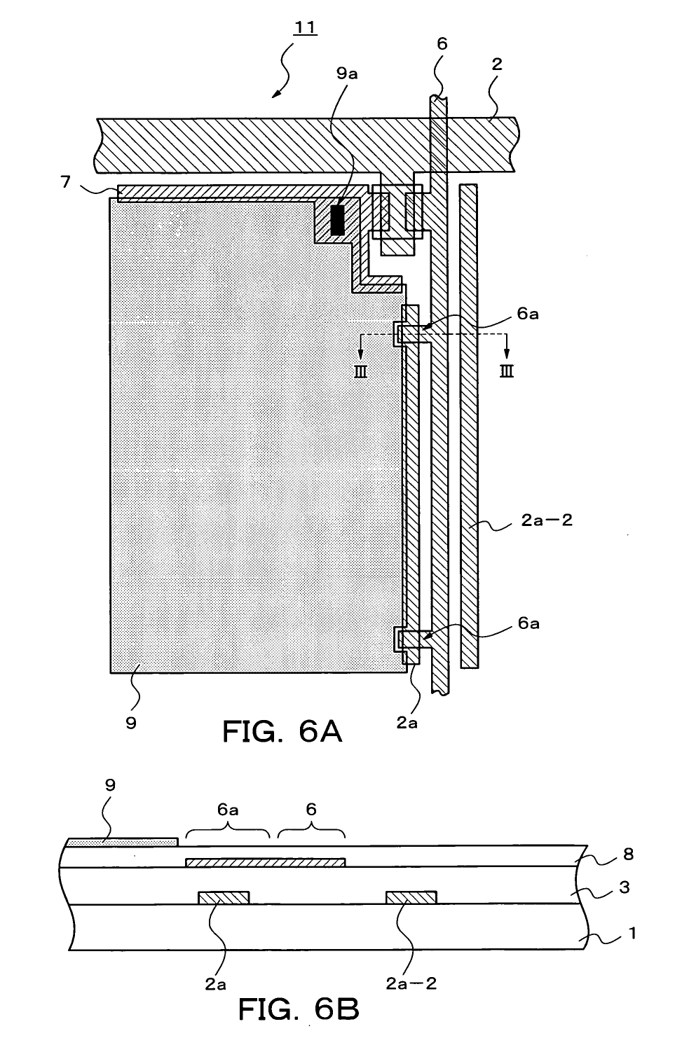

Next, channel etching is performed by removing part of the amorphous silicon or polysilicon in accordance with a dry etching method so as to expose a channel region which is sandwiched between the drain electrode and the source electrode 7. Thereafter, as shown in FIG. 6A and FIG. 6B, a passivation film 8 made of a silicon nitride film or the like is deposited in a thickness of several hundreds of nanometers in accordance with a plasma CVD method, for example. Then, the passivation film 8 in a position corresponding to the contact 9a is removed while using a fourth resist pattern formed thereon as a mask. Thereafter, a transparent conductive material such as ITO is formed in a thickness of several tens of nanometers by use of the sputtering method, for example, and wet etching is performed while using a fifth resist pattern formed thereon as a mask. In this way, the transparent pixel electrode 9 to be connected to the source electrode 7 at the contact 9a is thereby formed.

Here, it is preferable to form the peripheral portion of the transparent pixel electrode 9 to overlap the light-shielding conductive film 2a as described previously. However, if the protrusion 6a of the drain bus line 6 overlaps the transparent pixel electrode 9, capacitance is generated between the drain bus line 6 and the transparent pixel electrode 9 and the display quality is degraded. Therefore, when the protrusion 6a is apt to overlap the transparent pixel electrode 9, it is preferable to provide the transparent pixel electrode 9 with the recessed portions in the shape corresponding to the protrusions 6a in order to ensure the distances from the protrusions 6a.

Thereafter, the alignment film is coated thereon and then an aligning process is performed in a given direction. Meanwhile, in terms of the counter substrate facing the TFT substrate 11, the color filters in the respective colors of RGB are formed on the transparent insulative substrate, and the black matrix is formed in the position corresponding to the TFTs 5 and wiring around the transparent pixel electrodes 9. Thereafter, the counter electrode made of the transparent conductive material such as ITO is formed. Then, the alignment film is coated thereon and an aligning process is performed in a given direction. After sprinkling spacers made of inorganic fine particles having diameters of 4 to 5 μm, for example, the both substrates are attached together to form a given gap therebetween. The active matrix LCD of the exemplary embodiment of the present invention is finished after filling the liquid crystal into the gap between the both substrates.

Then, a display function is tested by displaying an appropriate display pattern on the finished LCD. If disconnection on the drain bus line 6 is found as a result of the test, the disconnected portion is repaired by use of a laser repair device or the like. Specifically, as shown in FIG. 7A and FIG. 7B, the protrusions 6a are welded and connected to the light shielding conductive film 2a by irradiating the laser beam set to predetermined power on the overlapping portions (laser irradiated portions 10) of the protrusions 6a and the light-shielding conductive film 2a. In other words, disconnection is repaired by forming the alternative path which runs through the drain bus line 6 above the disconnected portion 12, the protrusion 6a on the upper side, the light-shielding conductive film 2a, and the protrusion 6a on the lower side and returns to the drain bus line 6 below the disconnected portion 12.

As described above, the drain bus line 6 is provided with at least two protrusions 6a in terms of each pixel so as to protrude toward the light-shielding conductive film 2a and to overlap the light-shielding conductive film from the view point in the direction of the normal line of the substrate. In this way, the drain bus line 6 is rendered connectable to the light shielding conductive film 2a at the protrusions 6a. Therefore, even if disconnection occurs on the drain bus line 6, it is possible to bypass the disconnected portion by use of the light-shielding conductive film 2a.

Here, the shape of the protrusion 6a is not particularly limited in the case of the product type configured to reduce the widths of the bus lines in order to increase the aperture ratio. For this reason, even when the power of the laser is increased for lower resistance of the joint, the metal at the laser irradiated portion 10 will not disappear and no new disconnected portion will be generated. In addition, by allowing the drain bus line 6 and the light-shielding conductive film 2a to overlap each other only at the protrusions 6a, it is possible to minimize the area of the overlapping portions. In this way, parasitic capacitance can be also reduced.

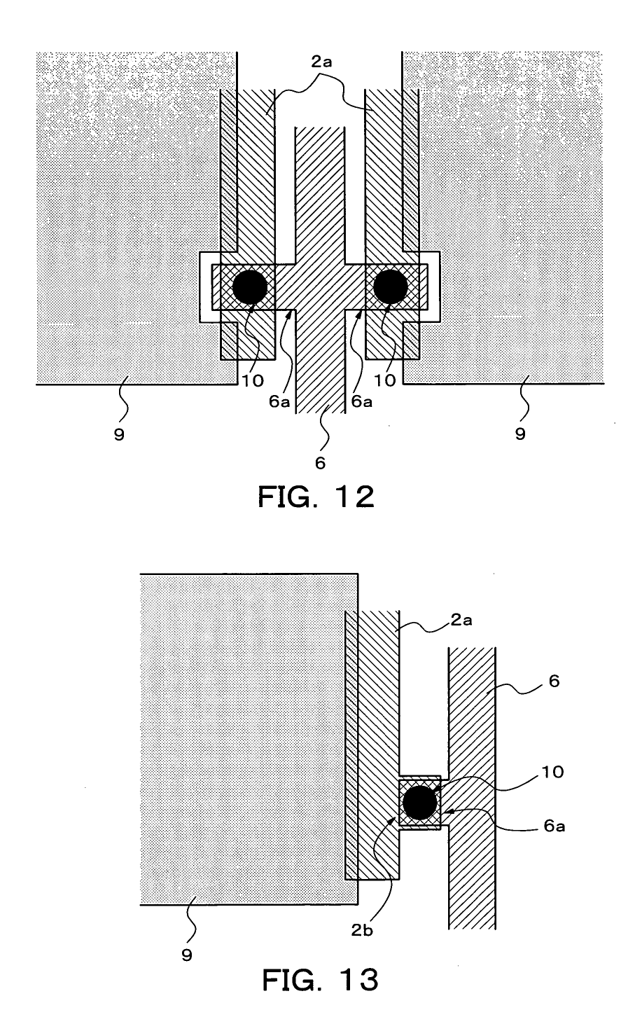

Note that FIG. 3 to FIG. 10 describe the configuration to connect the drain bus line 6 to the light-shielding conductive film 2a close to the pixel in which the TFT 5 to be connected to this drain bus line 6 is disposed. For example, as shown in FIG. 11, it is also possible to apply a configuration to connect the drain bus line 6 to the light-shielding conductive film 2a provided on an adjacent pixel (on the right pixel in the drawing) to the pixel in which the TFT 5 to be connected to this drain bus line 6 is disposed. Alternatively, as shown in FIG. 12, it is also possible to apply a configuration to provide the protrusions 6a on both sides of the drain bus line 6 and to connect the protrusions 6a to the light-shielding conductive films 2a on both sides.

Meanwhile, in FIG. 3 to FIG. 12, the light-shielding conductive film 2a is formed into the straight line, and the drain bus line 6 is provided with the protrusions 6a to overlap the light-shielding conductive film 2a. Alternatively, as shown in FIG. 13, for example, it is also possible to provide the drain bus line 6 with the protrusion 6a similarly and to provide the light-shielding conductive film 2a with a light-shielding conductive film protrusion 2b in a position corresponding to the protrusion 6a, thereby overlapping the both protrusions. In this configuration, the protrusion 6a of the drain bus line 6 does not overlap the base portion of the light-shielding conductive film 2a. Accordingly, it is possible to ensure the distance between the transparent pixel electrode 9 and the protrusion 6a. As a result, it is not necessary to provide the transparent pixel electrode 9 with the recessed portion as shown in FIG. 3. In this way, it is possible to design and manufacture the TFT substrate easily.

Moreover, the exemplary embodiment of the present invention has described the TFT substrate including channel etching type TFTs of the reverse stagger structure (a bottom gate structure). However, the present invention is not limited only to the above-described embodiment. The present invention is also applicable to a TFT substrate including any of channel protection type TFTs and TFTs of a forward stagger structure (a top gate structure). Moreover, the exemplary embodiment of the present invention describes the active matrix LCD configured to form the color filters on the counter substrate. However, the present invention is also applicable to a CF-on-TFT structure configured to form the color filters on the TFT substrate.

As described above, according to the configuration of the present invention, when disconnection occurs on the second bus line, the laser beam is irradiated on the protrusions or the second protrusions provided on the second bus line, and the second bus line is connected to the light-shielding conductive film by use of the protrusions or the second protrusions. In this way, it is possible to form the alternative path which bypasses the disconnected portion. Moreover, in this structure, even in the case of the product type configured to reduce the widths of the bus lines in order to increase the aperture ratio, it is possible to form the protrusions or the second protrusions into desired shapes. For this reason, even when the power of the laser is increased to reduce resistance of the joint, the metal at the laser irradiated portion will not disappear and no new disconnected portion will be generated at the laser irradiated portion. Moreover, the overlapping portion of the second bus line and the light-shielding conductive film can be restricted to the protrusion or the second protrusion. Accordingly, it is possible to reduce parasitic capacitance.

To be more precise, the LCD substrate and the repairing method for the LCD substrate of the present invention exert the following advantages.

A first advantage of the present invention is that it is possible to bypass the disconnected portion on the drain bus line.

This advantage is achieved because, in the structure including the light-shielding conductive film formed on the same layer as the gate bus lines and located between the drain bus line and the transparent pixel electrode, the drain bus line is provided with at least two protrusions. Here, each of the protrusions is configured to protrude toward the light-shielding conductive film and to have the portion overlapping the light-shielding conductive film from the viewpoint in the direction of the normal line of the substrate. In this way, when disconnection occurs on the drain bus line, it is possible to form the path for bypassing the disconnected portion by irradiating the laser beam on the protrusions and connecting the protrusions to the light-shielding conductive film.

Moreover, the configuration to form at least two first protrusions (the light-shielding conductive film protrusions 2b shown in FIG. 13) protruding toward the drain line, and to form the second protrusions (the protrusions 6a shown in FIG. 13) each protruding toward the light-shielding conductive film and including the portion overlapping the first protrusion from the view point in the direction of the normal line of the substrate also contributes to this advantage. In this way, when disconnection occurs on the drain bus line, it is possible to form the path for bypassing the disconnected portion by irradiating the laser beam on the second protrusions and connecting the second protrusions to the first protrusions.

Meanwhile, a second advantage of the present invention is that it is possible to avoid disconnection reliably.

This advantage is achieved because it is possible to set the shape of the protrusion arbitrarily even in terms of the product type configured to reduce the widths of the bus lines in order to increase the aperture ratio. In this way, even when the power of the laser is raised to reduce resistance of the joint, the metal at the laser irradiated portion will not disappear and no new disconnected portion will be generated at the laser irradiated portion.

Moreover, a third advantage of the present invention is that it is possible to reduce parasitic capacitance between the drain bus line and the light-shielding conductive film constituting the repair line.

This advantage is achieved because the layouts of the respective members are defined appropriately to allow the repair line to overlap the protrusions of the drain bus line instead of forming the repair line so as to overlap the drain bus line as indicated in the conventional example. Alternatively, the layouts of the respective members are defined appropriately to allow the second protrusions of the repair line to overlap the first protrusions of the drain bus lines. For this reason, it is possible to reduce the area of the overlapping portions.

It is apparent that the present invention is not limited to the above embodiments, but may be modified and changed without departing from the scope and spirit of the invention.

1. A liquid crystal display substrate comprising:
a substrate provide with plurality of first bus lines and a plurality of second bus lines crossing each others;
switching elements disposed in the vicinities of intersections of the first bus lines and the second bus lines;
transparent pixel electrodes formed inside respective pixel regions surrounded by the first bus lines and the second bus lines;
a light-shielding conductive film formed on the same layer as the first bus lines to include part of a region between each of the second bus lines and each of the transparent pixel electrodes; and
at least two protrusions provided on each of the second bus lines in terms of each of the pixel region, each of the protrusions being configured to protrude toward the light-shielding conductive film and to include a portion overlapping the light-shielding conductive film from a viewpoint in a direction of a normal line of the substrate,
wherein the second bus line is connected to the light-shielding conductive film by irradiating a laser beam onto the protrusions.

2. The liquid crystal display substrate according to claim 1,
wherein the protrusion is formed to cross the light-shielding conductive film.

3. The liquid crystal display substrate according to claim 2,
wherein the transparent pixel electrode comprises a recessed portion in a position facing the protrusion to secure a clearance with the protrusion.

4. A liquid crystal display substrate comprising:
a substrate provide with plurality of first bus lines and a plurality of second bus lines crossing each others;
switching elements disposed in the vicinities of intersections of the first bus lines and the second bus lines;
transparent pixel electrodes formed inside respective pixel regions surrounded by the first bus lines and the second bus lines;
a light-shielding conductive film formed on the same layer as the first bus lines to include part of a region between each of the second bus lines and each of the transparent pixel electrodes;
at least two first protrusions provided on the light-shielding conductive film in terms of each of the pixel regions, each of the first protrusions being configured to protrude toward the second bus line; and
second protrusions provided on the second bus line and located in positions corresponding to the first protrusions, each of the second protrusions being configured to protrude toward the light-shielding conductive film and to include a portion overlapping the first protrusion from a viewpoint in a direction of a normal line of the substrate,
wherein the second bus line is connected to the light-shielding conductive film by irradiating a laser beam onto the second protrusions.

5. The liquid crystal display substrate according to claim 4,
wherein the second protrusion is formed to cross the light-shielding conductive film.

6. The liquid crystal display substrate according to claim 5,
wherein the transparent pixel electrode comprises a recessed portion in a position facing the second protrusion to secure a clearance with the second protrusion.

7. A method of repairing a liquid crystal display substrate, comprising:
forming a plurality of first bus lines located on a lower layer and a plurality of second bus lines located on an upper layer to extend in a substantially orthogonal direction to the first bus lines;
arranging switching elements to be disposed in the vicinities of intersections of the first bus lines and the second bus lines;
forming transparent pixel electrodes inside respective pixel regions surrounded by the first bus lines and the second bus lines;
forming a light-shielding conductive film on the same layer as the first bus lines to include part of a region between each of the second bus lines and each of the transparent pixel electrodes; and
providing each of the second bus lines with at least two protrusions in terms of each of the pixel regions, each of the protrusions being configured to protrude toward the light-shielding conductive film and to include a portion overlapping the light-shielding conductive film from a viewpoint in a direction of a normal line of the substrate,
wherein the second bus line is connected to the light-shielding conductive film by irradiating a laser beam onto the protrusions provided on both sides of a disconnected portion when disconnection occurs on the second bus line to form a path for bypassing the disconnected portion.

8. The method of repairing a liquid-crystal display substrate according to claim 7,
wherein the protrusion is formed to cross the light-shielding conductive film.

9. The method of repairing a liquid crystal display substrate according to claim 8,
wherein a recessed portion is formed on the transparent pixel electrode in a position facing the protrusion to secure a clearance with the protrusion.

10. A method of repairing a liquid crystal display substrate, comprising:
forming a plurality of first bus lines located on a lower layer and a plurality of second bus lines located on an upper layer to extend in a substantially orthogonal direction to the first bus lines;
arranging switching elements to be disposed in the vicinities of intersections of the first bus lines and the second bus lines;
forming transparent pixel electrodes inside respective pixel regions surrounded by the first bus lines and the second bus lines;
forming a light-shielding conductive film on the same layer as the first bus lines to include part of a region between each of the second bus lines and each of the transparent pixel electrodes,
providing the light-shielding conductive film with at least two first protrusions in terms of each of the pixel regions, each of the protrusions being configured to protrude toward the second bus line; and
providing each of the second bus lines with second protrusions in positions corresponding to the first protrusions, each of the second protrusions being configured to protrude toward the light-shielding conductive film and to include a portion overlapping the first protrusion from a viewpoint in a direction of a normal line of the substrate,
wherein the second protrusions on the second bus line are connected to the first protrusions on the light-shielding conductive film by irradiating a laser beam onto the second protrusions provided on both sides of a disconnected portion when disconnection occurs on the second bus line to form a path for bypassing the disconnected portion.

11. The method of repairing a liquid crystal display substrate according to claim 10,
wherein the second protrusion is formed to cross the light-shielding conductive film.

12. The method of repairing a liquid crystal display substrate according to claim 11,
wherein a recessed portion is formed on the transparent pixel electrode in a position facing the second protrusion to secure a clearance with the second protrusion.
